(19) United States
(12) Patent Application Publication
(10) Pub. No.: US 2014/0192000 A1
(43) Pub. Date: Jul. 10, 2014

(54) DISPLAY SYSTEM HAVING ELECTROPHORETIC TOUCH PANEL

(71) Applicant: SiPix Technology, Inc., Taoyuan (TW)

(72) Inventors: Chi-Mao Hung, Hsinchu City (TW); Chih-Yuan Hsu, Taipei City (TW); Wei-Min Sun, Taipei City (TW); Pei-Lin Tien, Taichung City (TW); Kuan-Chang Ho, Taichung City (TW); Yee-Hua Tsai, Taipei City (TW)

(73) Assignee: SiPix Technology, Inc., Taoyuan (TW)

(21) Appl. No.: 14/149,786

(22) Filed: Jan. 7, 2014

(30) Foreign Application Priority Data
Jan. 10, 2013 (TW) 102100887

(51) Int. Cl. G09G 3/34; G09G 3/36; G09G 3/32; G06F 3/041

(52) U.S. Cl. CPC G09G 3/344; G06F 3/0416; G09G 3/3648; G09G 3/3225
USPC 345/173

(57) ABSTRACT

A display system includes a display panel and an electrophoretic touch panel. The electrophoretic touch panel is optionally coupled to or separated from the display panel. When the electrophoretic touch panel is coupled to the display panel, the electrophoretic touch panel displays an input interface for inputting a signal to the display panel.

### BACKGROUND OF THE INVENTION

1. Field of the Invention

The present invention relates to a display system, especially a to a display system including an electrophoretic touch panel.

2. Description of the Prior Art

Due to their slim shapes, low power dissipation and low radiation characteristics, flat panel displays are widely applied in mobile electronic devices such as notebooks, monitors, and PDAs (personal digital assistants). Recently, the electrophoretic touch panels, also called electronic paper, are provided. The electrophoretic touch panel has a slimmer shape and is soft enough to be bent, and has the advantage of being conveniently portable. Besides, the electrophoretic touch panel can retain the displayed image such as photos and text even without being provided with voltage.

Compared with notebooks, the electrophoretic touch panel is more portable and dissipates less power. However, compare with the notebook having a keyboard, the electrophoretic touch panel is less convenient to input commands.

### SUMMARY OF THE INVENTION

An embodiment of the present invention relates to a display system. The display system comprises a display panel and an electrophoretic touch panel. The electrophoretic touch panel is optionally coupled to or separated from the display panel. When the electrophoretic touch panel is coupled to the display panel, the electrophoretic touch panel displays an input interface for inputting a signal to the display panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a display system according to a first embodiment of the present invention.

FIG. 2 shows a display system according to a second embodiment of the present invention.

FIG. 3 shows a display system according to a third embodiment of the present invention.

### DETAILED DESCRIPTION

The detailed descriptions of the present invention are exemplified below in examples. However, the examples are merely used to illustrate the present invention, not to limit the present invention. Because one skilled in the art may modify the present invention or combine the present invention with some features within the scope of the present invention, the claimed scope of the present invention should be referred to in the following claims. In the present specification and claims, the term “comprising” is open type and should not be viewed as the term “consisted of.” Besides, the terms “electrically couple” and “couple” can be referring to either directly connecting or indirectly connecting between elements. Thus, if it is described in the below contents of the present invention that a first device is electrically coupled to a second device, the first device can be directly connected to the second device, or indirectly connected to the second device through other devices or means.

The embodiments and figures are provided as follows in order to illustrate the present invention in detail, but the claimed scope of the present invention is not limited by the provided embodiments and figures. Further, the numbers of steps performed in the methods of the present invention are not used to limit the priority of performing steps of the present invention. Any methods formed by recombining the steps of the present invention belong to the scope of the present invention.

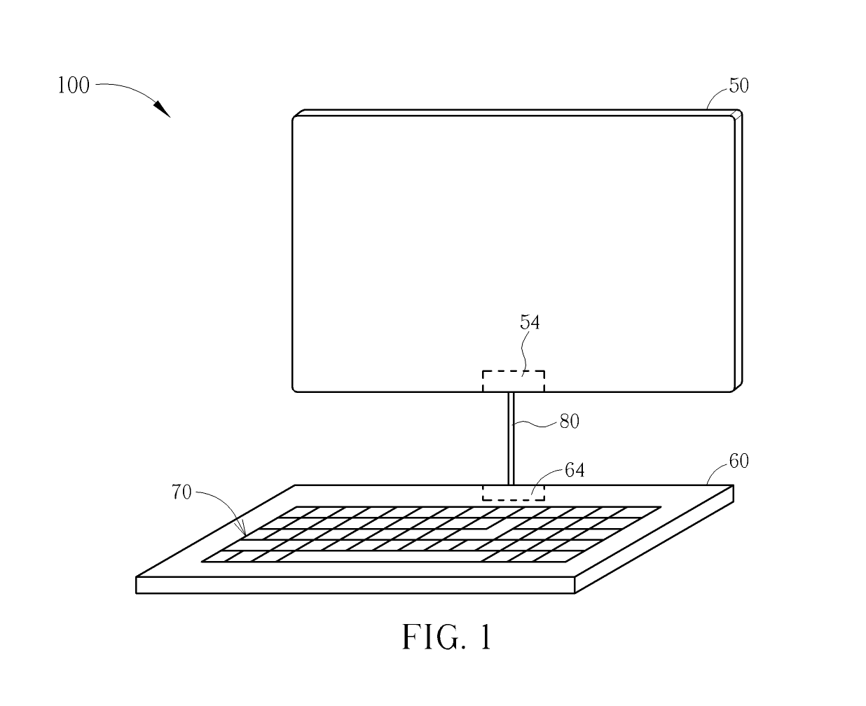

Please refer to FIG. 1, which shows a display system 100 according to a first embodiment of the present invention. As shown in FIG. 1, the display system 100 comprises a display panel 50 and an electrophoretic touch panel 60. The electrophoretic touch panel 60 can be optionally coupled to or separated from the display panel 50. When the electrophoretic touch panel 60 is coupled to the display panel 50, the electrophoretic touch panel displays an input interface 70 for inputting a signal to the display panel 50.

When the electrophoretic touch panel 60 is electrically disconnected from the display panel 50, the electrophoretic touch panel 60 will not display the input interface 70, but will display an electronic reader interface or a hand-writing panel interface instead. The display panel 50 can be the display panel of a tablet, and can be an electrophoretic display panel, a liquid crystal display (LCD) or an active matrix organic light emitting diode (AMOLED) display. The input interface 70 can be a virtual keyboard, a virtual indicator input device or a virtual mouse capable of providing multimedia images for the users to operate accordingly.

The display panel 50 comprises a first signal interface 54, and the electrophoretic touch panel 60 comprises a second connection member 64. The electrophoretic touch panel 60 is electrically connected to the display panel 50 through coupling the first signal interface 54 to the second signal interface 64, so that the electrophoretic touch panel 60 and the display panel 50 can transmit signal each other. For example, the first signal interface 54 and the second signal interface 64 can be USB (Universal Serial Bus) ports, HDMI (High Definition Multimedia Interface) ports, VGA (Video Graphics Array) connection ports, and so on.

In the first embodiment, through using the electrophoretic touch panel 60 as the signal input device of the display panel 50, the user can conveniently input commands to the display 50 without using an entity keyboard or an entity mouse. Besides, the electrophoretic touch panel 60 has a slim shape and is not heavy, thus is conveniently portable for the user to carry outside. Further, the electrophoretic touch panel 60 can be independently used as an electronic reader after being electrically disconnected from the display panel 50.

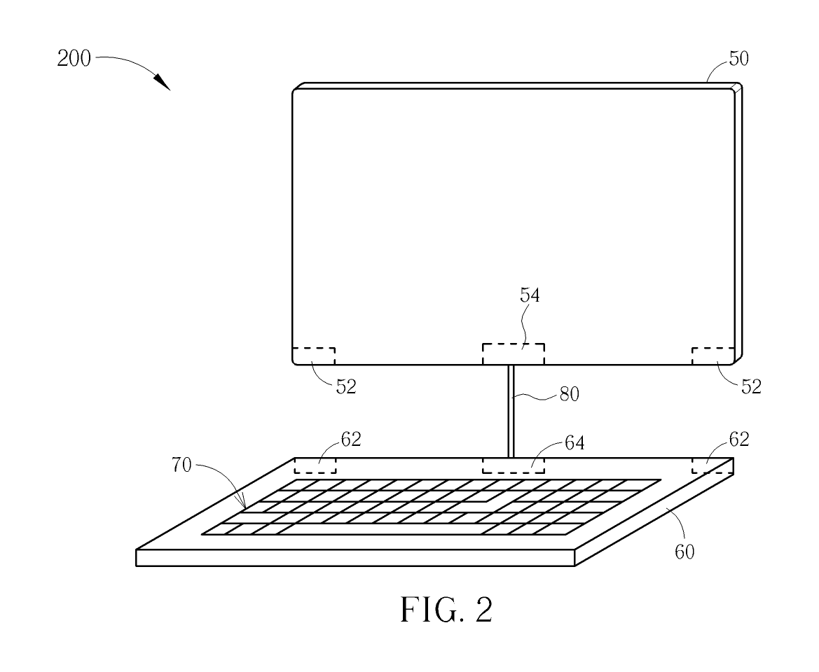

Please refer to FIG. 2, which shows a display system 200 according to a second embodiment of the present invention. As shown in FIG. 2, the difference between the display systems 200 and 100 is that, in the display system 200, the display panel 50 further comprises a first connection member 52, and the electrophoretic touch panel 60 comprises a second connection member 62. The first connection member 52 and the second connection member 62 can be members for connecting the display panel 50 to the electrophoretic touch panel 60 such as two matched latches or intersecting rings. Besides, the first connection member 52 and the second connection member 62 can be fixed to each other with screws, and the numbers of the first connection member 52 and the second connection member 62 are not limited. Through connecting the first connection member 52 and the second connection member 62, the display panel 50 and the electrophoretic touch panel 60 can be physically connected. Through the configurations in the second embodiment, the connection of the display panel 50 and the electrophoretic touch panel 60 can be strengthened, and the overall volume of the display system 200 can be reduced.

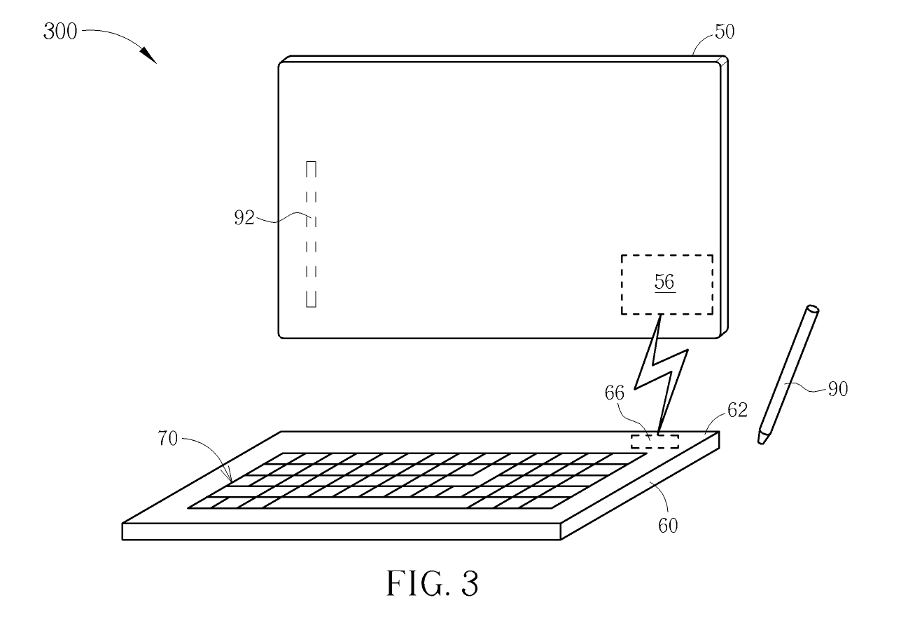

Please refer to FIG. 3, which shows a display system 300 according to a third embodiment of the present invention. As shown in FIG. 3, the difference between the display systems 300 and 100 is that, in the display system 300, the display panel 50 further comprises a first wireless communication unit 56 without necessarily comprising the first signal interface 54. The electrophoretic touch panel 60 further comprises a second wireless communication unit 66 without necessarily comprising the second signal interface 64. The electrophoretic touch panel is electrically connected to the display panel through wireless coupling of the first wireless communication unit to the second wireless communication unit to transmit the signal. The first wireless communication unit 56 and the second wireless communication unit 66 can be configured to conform to a wireless fidelity (WiFi) specification or another wireless transmission specification to perform wireless transmissions. Through the configurations in the third embodiment, the transmissions between the display panel 50 and the electrophoretic touch panel 60 can be wireless and do not need the transmission line 80.

The aforementioned first to third embodiments are illustrated as examples, not used to limit the scope of the present invention. Besides, the features of the first to third embodiments can be combined. For example, besides comprising the first wireless communication unit 56 and the second wireless communication unit 66, the display system 300 can be configured to further comprise the first signal interface 54 and the second signal interface 64 in FIG. 1. Any methods and means of controlling an electric display device by using the electrophoretic touch panel 60 as the input device belong to the scope of the present invention. Further in the third embodiment, the system 300 can be configured to comprise a touch pen 90 for performing touch to the electrophoretic touch panel 60 and the display panel 50, and to comprise a fixing mechanism 92 for accommodating the touch pen 90, for the user to conveniently carry the touch pen 90. The aforementioned touch pen 90 and the fixing mechanism 92 can be also applied in the first or second embodiment, and the fixing mechanism 92 can be configured on the electrophoretic touch panel 60.

In view of above, through the configurations of the first to third embodiments, when using the electrophoretic touch panel 60 as the signal input device to operate the display panel 50, the user need not further use an entity keyboard or an entity mouse. Besides, the electrophoretic touch panel 60 has a slim shape and is not heavy, thus is conveniently portable for the user to carry. Further, the electrophoretic touch panel 60 can be independently used as an electronic reader after being electrically disconnected from the display panel 50.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display system, comprising:
a display panel; and
an electrophoretic touch panel, optionally coupled to or separated from the display panel;
wherein when the electrophoretic touch panel is coupled to the display panel, the electrophoretic touch panel displays an input interface for inputting a signal to the display panel.

2. The display system of claim 1, wherein the display panel comprises a first connection member, and the electrophoretic touch panel comprises a second connection member, and connecting the first connection member to the second connection member connects the display panel to the electrophoretic touch panel.

3. The display system of claim 1, wherein the display panel comprises a first signal interface, and the electrophoretic touch panel comprises a second connection member, the electrophoretic touch panel is electrically connected to the display panel through coupling the first signal interface to the second signal interface, to transmit the signal.

4. The display system of claim 1, wherein the display panel comprises a first wireless communication unit, and the electrophoretic touch panel comprises a second wireless communication unit, the electrophoretic touch panel is electrically connected to the display panel through wirelessly coupling of the first wireless communication unit to the second wireless communication unit, to transmit the signal.

5. The display system of claim 4, wherein the first wireless communication unit and the second wireless communication unit conform to a wireless fidelity (WiFi) specification.

6. The display system of claim 1, wherein the input interface is a virtual keyboard, a virtual indicator input device or a virtual mouse.

7. The display system of claim 1, wherein the display panel is an electrophoretic display panel, a liquid crystal display (LCD) or an active matrix organic light emitting diode (AMOLED) display.

8. The display system of claim 1, wherein when the electrophoretic touch panel is electrically disconnected from the display panel, the electrophoretic touch panel displays an electronic reader interface or a hand-writing panel interface.

9. The display system of claim 1, further comprising a touch pen for performing touch to the electrophoretic touch panel and the display panel.

10. The display system of claim 9, further comprising a fixing mechanism for accommodating the touch pen.
